(19) United States
(12) Patent Application Publication
(10) Pub. No.: US 2009/0094235 A1
(43) Pub. Date: Apr. 9, 2009

(54) Ordering directory assistance search results by local popularity of search results

(75) Inventors: Gregory T. White, Carlisle, MA (US); Arni J. Joyce, West Newton, MA (US); John Petropoulos, Groton, MA (US); Scott A. Kliger, Franklin, MI (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: Jingle Networks, Inc., Bedford, MA (US)

(21) Appl. No.: 12/284,722

(22) Filed: Sep. 24, 2008

Related U.S. Application Data
(60) Provisional application No. 60/995,096, filed on Sep. 24, 2007.

(51) Int. Cl. G06F 17/30; H04M 3/42

(52) U.S. Cl. 707/5; 379/218.01

(57) ABSTRACT

A platform for ordering search results according to result popularity a directory assistance service, itself, to determine the popularity of the listings associated with a particular category and, therefore, the order in which those listings should be delivered resulting from a category search. Priority may be determined by the popularity of each search result. For example, directory assistance users in a particular location will likely know which businesses have a reputation for providing the best service or highest-quality products. Such factors will determine the popularity of these businesses. Businesses that are more popular are likely to be selected more frequently from the category search results than those that are less popular. The system may examine the history of search results for each listing and order the results of a particular category search according to the number of historical requests for each returned listing.

### RELATED APPLICATION

This application claims the benefit of U.S. Provisional Application No. 60/995,096, filed on Sep. 24, 2007. The entire teachings of the above application are incorporated herein by reference.

### BACKGROUND OF THE INVENTION

Telephone directory assistance continues to be an extremely important service for consumers and businesses. It is estimated that there are approximately 8 billion telephone calls placed to directory assistance services (i.e., 411, 555-1212) in the United States each year. The average cost billed for these calls is in excess of $1.00.

To date there is truly no comprehensive telephone based directory assistance available. In particular, consumers may be looking for a business for which they know a category (i.e., plumber, lawyer, travel agent, taxi, etc.) but for which they do not know a name and/or location. There is also no way for a consumer to use a telephone to search by “keyword” for a product or service they wish to purchase. These types of searches are still reserved for consumers to use traditional sources such as the “yellow pages.” Increasingly now, consumers can also turn to internet based on line directories and search engines for this type of search.

Directory searches often tend to be local in nature, meaning that the consumer is actually looking for a merchant in their immediate geographic area. Generally, currently-available directory assistance systems present search results in a random or round-robin order, or by bid amount to maximize revenue generated by advertising sales. These ordering methods do not serve the best interest of the customer, but rather are solely self-serving for the directory-assistance provider.

### SUMMARY OF THE INVENTION

Typically, customers would rather seek out reputable merchants or service providers over those that are lesser-known. Such merchants or service provides likely are to be more popular among local consumers than those that provide inferior products or services. Thus, the present invention seeks to provide a directory assistance system that instead is more tailored to consumers' preferences, rather than to advertisers'. Example embodiments of the present invention relate to a system and method of ordering search results in response to a directory assistance search request, which may be made by a directory assistance user in a public telecommunication network. The search request is examined to identify a category associated with the search request. Based on that category, a database is searched for search results which have at least a popularity value. The popularity value associated with each search result is indicative of the number of times each respective returned search result has been selected by users from the returned search results of previous search requests. Search results associated with the category also have geographic values. Returned results will have geographic values within a distance from a location associated with the directory assistance user. Those returned results are then ordered according to their respective popularity values.

From a user's perspective, the likelihood of getting a high-quality result rises dramatically when search results are returned that were popular selections among past users making directory assistance searches. From a monetization perspective, the more likely that a directory assistance service provider provides a good paid result, the more likely that the user will choose that result, and the more likely the service provider will make money from that result.

For example, if a directory assistance user requests dentists in Boulder, Colo., two possible results are Boulder Dental Care and Boulder Orthodontists, both of which are classified under “dentists.” By using popularity rankings, however, it would be possible and more likely to present Boulder Dental Care to a user. This would be a much higher-quality result, and therefore much more likely of being correct because a user is more likely to search for “orthodontist” if looking for an orthodontist. Therefore, a user making such a search request is likely searching for a dentist, for example, to schedule a routine examination or cleaning. This is interesting, at least, for “organic,” unpaid results. However, for paid results, a service provider's expected yield for playing the advertisements is the probability that the user is going to act multiplied by the yield if the user does act. Thus, the higher the service provider is able to raise the probability that the returned result is a result the user will be interested in, the more likely that the service provider is going to make money from any advertisement associated with the returned result.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a high level diagram of a directory assistance system.

FIG. 2 is a table illustrating rows returned from a listing database.

FIG. 3 is a flow diagram illustrating an example interaction between a directory assistance user and a directory assistance system.

FIG. 4A is a flow diagrams of example methods by which results may be ordered according to their local popularity.

FIGS. 4B-4C are flow diagrams of example methods by which the popularity value of returned results may be determined.

FIG. 5 is a flow diagram of an example method by which the popularity value of returned results may be maintained.

FIG. 6A is a diagram illustrating selection of returned results with geographic values within a search area.

FIGS. 6B-6C are diagrams illustrating selection of returned results with popularity areas within a search area.

### DETAILED DESCRIPTION OF THE INVENTION

A description of example embodiments of the invention follows.

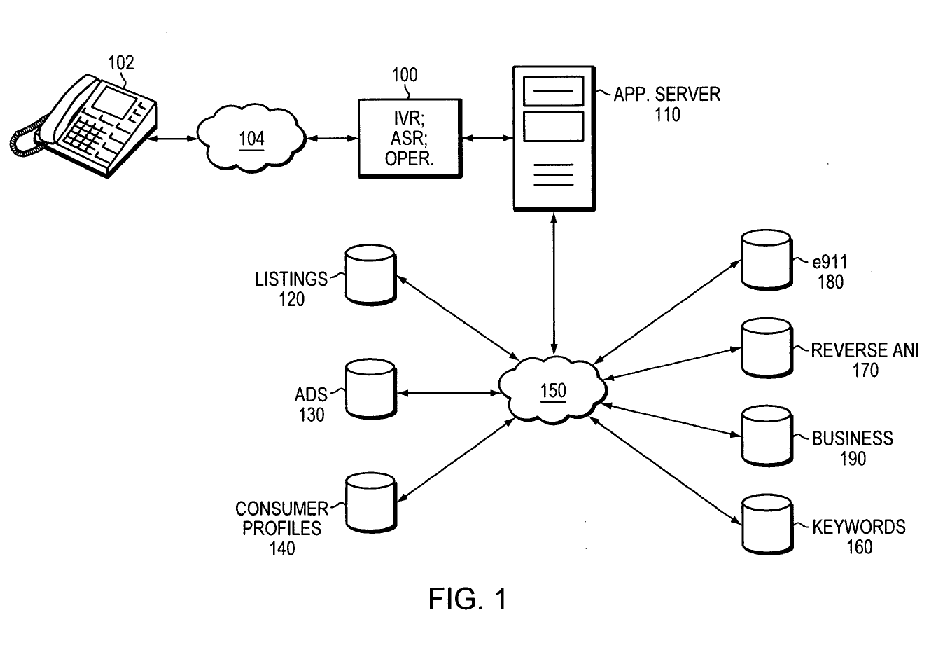

Now to describe technical aspects of one preferred embodiment of the invention, in reference to FIG. 1, the invention can be implemented using an application server 110 which can receive information originating from a Public Switched Telephone Network (PSTN) 104, specifically via a call originating from a consumer who is using a telephone 102.

The server 110 can receive information requests as data in many ways. In one preferred arrangement, the information is provided via an Interactive Voice Response (IVR)/Automated Voice Recognition (AVR) system 106. The IVR portion of system 106 has some type of interface to obtain a search request from the user, and provide the request as data. For example, the information request can be provided in data form via a keypad (Dual Tone Multi-Frequency (DTMF) digits), by voice recognition software that recognizes speech, and/or via a live operator who speaks to the consumer live and then keys in the request as text. The AVR portion of system 106 provided automatic recognition of the voice signals provided by the consumer.

The application server 110 is connected through the internet 150 (and/or local networks) to various other databases and/or information servers. These include, for example, a listings database 120, an ad server 130, a consumer profile database 140, a keyword database 160, a reverse Automatic Number Identifier (ANI) database 170, an emergency 911 number look-up database 180, a business listings database 190 and other possible paid-subscription or free services or databases. FIG. 1 should be considered a logical view of the various databases; that is, although the drawings illustrates these databases as individual discrete entities each having their own server, it should be understood that one, several, or all of the databases may be consolidated in one physical machine, or that one or more of the databases may be so large as to be distributed among multiple servers and physical processors and/or disk drives.

In general, the application server 110 crafts a search query from the information supplied by the consumer via the telephone 102. The information is then packaged as part of a search query submitted to the private listings database 120. The listings 120 database may contain information concerning advertisers who have paid a fee to be listed in the system or agreed to pay for each call which is directed to them as the result of a consumer inquiry.

The application server 110 can also access a business database 190 which may be hosted by another service provider, for example as a paid service, to locate information that is not in the listings database 120. The business database query 190 can be used, for example, to provide general information listings responsive to the user's request. As for the case of the listings database 120, the location of the caller can be determined by making a query to the reverse ANI database 170 prior to querying the listings database 120. (Please note that the standard ANI service provides information concerning the calling parties' telephone number, such as might also be determined from the phone number portion of a “caller ID” determination, although ANI is not the same service as caller ID in the United States.)

For example, if the search request comes in on a particular telephone number, that telephone number can then be used to obtain a location of the calling telephone 102. This location can then be combined with the category of the search request as a submission to the listings 120 database.

Also note that the listings database 120 is not necessarily limited to just having a list of businesses as grouped into categories by a local telephone exchange service provider. For example, custom groupings may be determined by the system provider, such as by grouping businesses by their telephone number, or other combinations without regard to specific, predefined business or services categories.

Another database that may be kept is a keywords database 160. The keywords database 160 may be located several different places, such as a separate database 160, or it may be part of the listings 120 or business database 190, or part of the server 110 itself.

Further information may be maintained in a consumer profile database 140 that is kept on a per telephone number basis. Such information may include, but is not limited to, data indicating past queries and the responses to those inquires. It should be understood that other identifiers may be used to specify a particular individual consumer. For example, the system may keep data on a home phone number, a mobile phone number, and an office phone number together with a unique identifier for the individual. This may also be beneficial as many people now use more than one number.

The service provider operating application server 110 may thus typically develop its own listings database 120 that are paid listings. The paid listings may be categorized by and/or prioritized by popularity, as well as highest bid, proximity to the caller or any one of a number of different criteria supported by the system. A listings query can also be satisfied by a random search, a geography match, matching an advertiser willing to pay the most to reach a caller of indicated type previous positive consumer feedback or other criteria. Various partial and/or weighted combinations of these factors may also be used in determining the ads to be played back.

The business database 190 may itself be a paid service to which the operator of application server 110 subscribes, or may be provided as the result of an automated internet search itself.

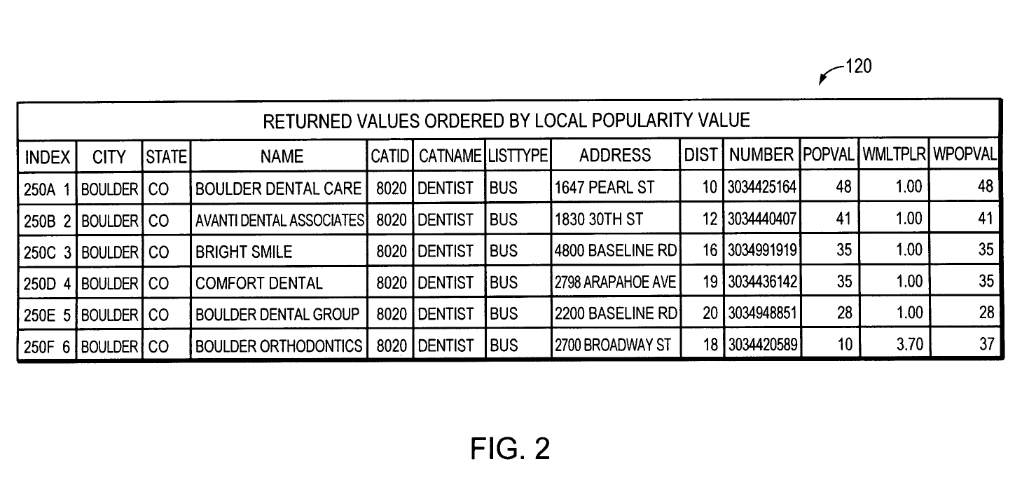

FIG. 2 illustrates a table containing example rows from the listings database 120. As can be seen in FIG. 2, which represents returned results 250a-250f of a search, the rows contain fields such as an index value (INDEX), address (ADDRESS), distance in miles from the search location (DIST), city (CITY) and state (STATE) of the listing, category identifier (CATID) (e.g., Standard Industrial Classification (SIC) code), category name (CATNAME) (e.g., dentist), listing type (LISTTYPE) (e.g., BUS for business), telephone number (NUMBER), popularity value (POPVAL), weighting multiplier (WMLTPLR), and weighted popularity value (WPOPVAL). Here, the results are ordered by popularity value (POPVAL) according to an example embodiment of the present invention. However, according to other example embodiments of the present invention, the results may be ordered according to the respective weighted popularity values (WPOPVAL). The popularity value associated with each search result indicates the number of times each respective returned search result has been selected by users from the returned search results of previous search requests. A returned result's popularity value also may be considered a percentage of the number of times it was selected from the total number of selections. Therefore, as illustrated in FIG. 2, the sum of all values of POPVAL is 197. Thus, although not shown in FIG. 2, the respective percentages for the returned results 2501-250f are 24%, 21%, 18%, 18%, 14% and 5%.

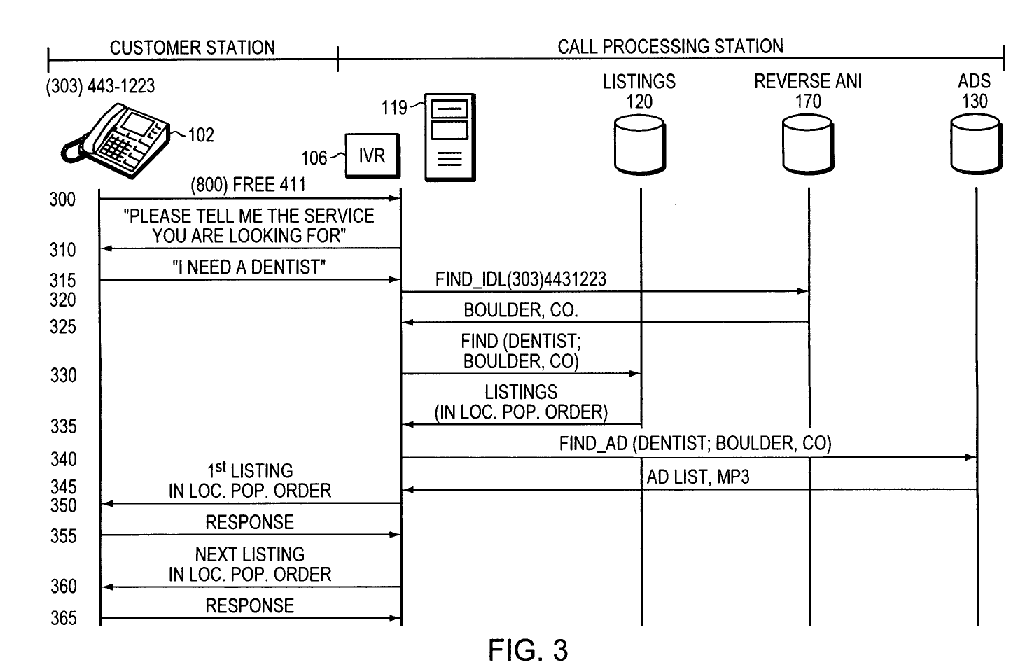

FIG. 3 illustrates an exchange of dialog and other information between a consumer (C) (i.e., a directory assistance user), using telephone 102, and the application server (S) 110, and is a general example of an exchange where the consumer is seeking assistance to obtain a yellow pages listing without being charged for the call. The consumer needs a dentist in this example call 300. First, the server 110 through the IVR 106, queries the consumer 102 (310), to which the consumer 102 responds with a request query (315) containing a category.

S: “Please tell me the service you are looking for”. (310)

C: “I need a dentist”. (315)

At this point the system 110 performs the above indicated search of the number lookup database 170 and listing database 120 to locate dentists in the immediate area located adjacent to the consumer 102. The results of this search are shown in the table illustrated in FIG. 2.

For example, suppose the consumer's telephone 102 number was identified as being in Boulder, Colo. (325) by a query (320) to the reverse number lookup database 170. The application server 110 then searches its listings database 120 (330) to locate a listing in Boulder in the “Dentist” category that has been ranked according to local popularity (335). The consumer then hears the following ad retrieved (345) from ad database 130:

S: “Boulder Dental Care. If you would like to be connected to this listing press, the # key. Otherwise please wait a moment”. (350)

The private listings database 120 would thus contain a listing for Boulder Dental Care 250a, and a link to the identified playback, which may be as simple as playing back the words “Boulder Dental Care” but which could be more elaborate, such as a more lengthy advertisement for Boulder Dental Care. This first returned listing 250a (350) was the one determined to be the most popular among the results in the “Dentist” category, as illustrated in the table shown in FIG. 2, based on factors such as the number of times Boulder Dental Care has been selected previously by users in the past, the geographic location of users, the geographic search area, and/or physical proximate location to the calling consumer. Note that the consumer is given the option to be connected to the indicated number or to continue listening for further information (355).

Priority of the first search result returned may be determined by the popularity of each search result. For example, directory assistance users in a particular location will likely know which businesses have a reputation for providing the best service or highest-quality products, or are simply popular for the sake of being trendy, flashy, exciting or fun. Such factors will influence the number of times each is selected from the returned search results of a directory assistance user's search request, thereby indicating each respective search result's popularity. Businesses that are more popular are likely to be selected more frequently from the category search results than those that are less popular.

Assuming that the consumer does not press the # key within a predetermined period of time, the consumer will next hear:

S: “Avanti Dental Associates. We have your best smile in mind! If you would like to be connected to this listing press #, for more options press the * key.” (360)

At this point the consumer is being prompted with a listing that was of lower priority (360). The system then awaits a response (365).

Continuing with the above example, if the consumer presses * in result in response to the prompt, she might hear the following:

S: “to move forward or back in the listings, press 1 for forward or 2 for back, to bookmark a listing so that it can be retrieved for further reference, press 3.”

These options in the Interactive Voice Response system 106 allow the user to keep track of where they are in a list of multiple listings sorted by local popularity.

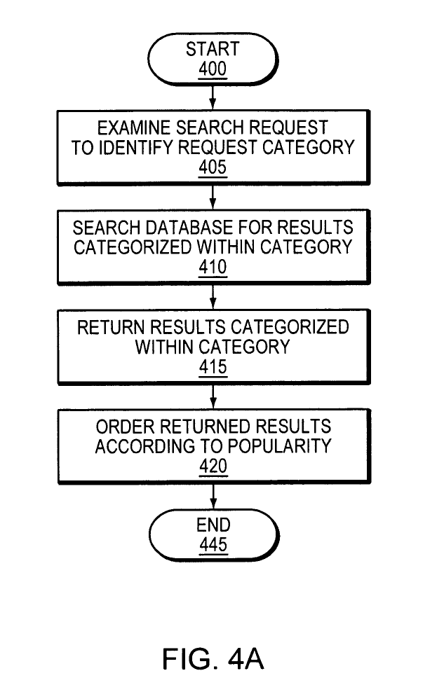

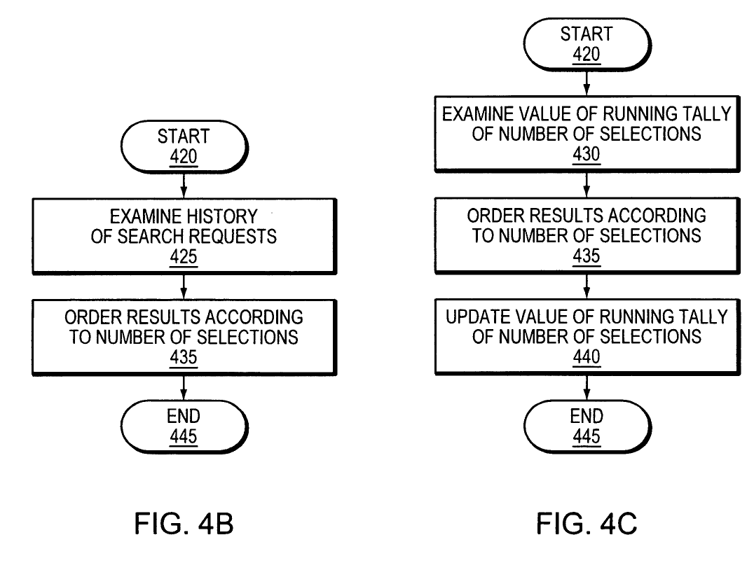

FIG. 4A is a flow diagram illustrating an example method for ordering search results in response to a directory assistance search request by a directory assistance user in a public telecommunication network. After receiving a search request (400), for example, from a customer at a telephone 102, the search request is examined to identify a category associated with the search request (405). A database of listings, such as the listings database 120, is searched (410) for results categorized within the category. The search results are then returned (415) and ordered (420) according to their respective popularity values.

As illustrated in FIG. 4B, the system may order returned results according to popularity (420) by examining the history of search results in which each listing was selected (405) and order the results of a particular category search according to the number of historical selections for each returned listing (435). In another example embodiment, as illustrated in FIG. 4C, the system may order returned results according to popularity (420) by examining the value of a running tally associated with each listing indicating the number of times the listing has been selected (430). This popularity search component of the directory assistance system thereby allows the directory assistance system, itself, to determine the popularity of the listings associated with a particular category and, therefore, the order (435) in which those listings should be delivered resulting from a category search ordered by popularity. The value is then updated (440) after each subsequent selection. The methods illustrated in the flow diagrams of FIGS. 4A-4C then end (445).

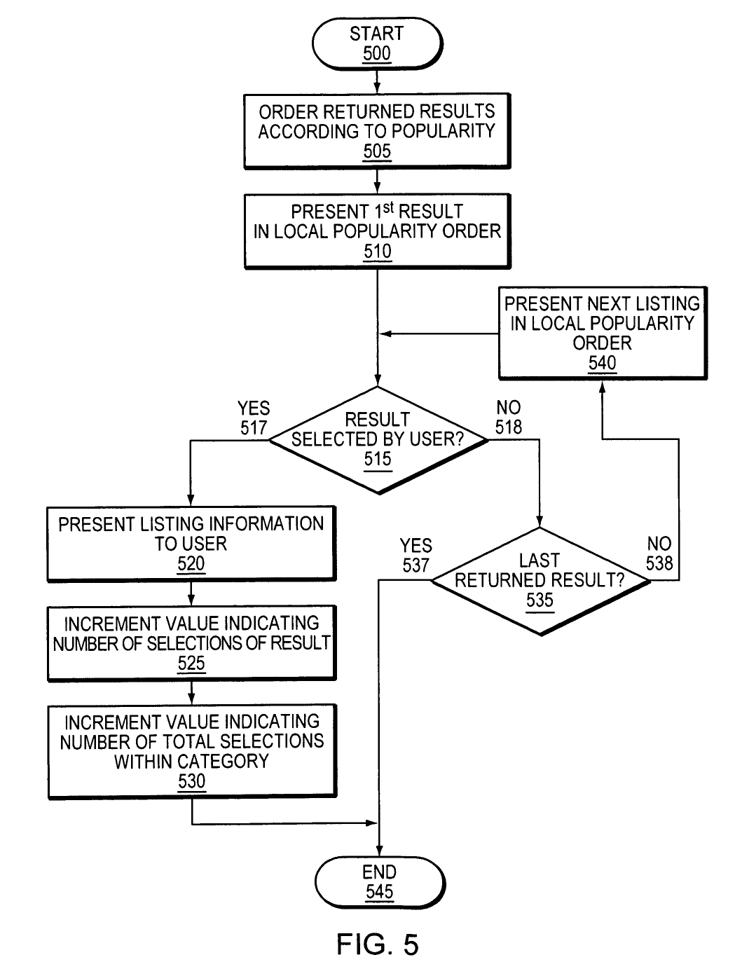

FIG. 5 illustrates a method similar to the methods illustrated in the flow diagrams of FIGS. 4A and 4C. The method starts (500) upon receiving a request query from a user. After searching, results of the search are ordered (505) according to their popularity value. The result with the highest popularity value is then presented to the user (510). The user is then given an opportunity to select the presented result (515). If the result is not selected by the user (518), the system determines whether it was the last returned result (535). If it was the last returned result (537), the method ends (545). However, if it was not the last result (538) and additional results were provided following the search and ordered according to their popularity, the next listing in local popularity order is presented (540). The method then returns to determine whether the user selects the next-presented result (515).

If a result is selected by the user (517), listing information for the results is presented to the user (520). Then the popularity value associated with the result indicating the number of selections by users of that result is incremented (525). Further, the number of total selections made by users is also incremented (530). The method then ends (545).

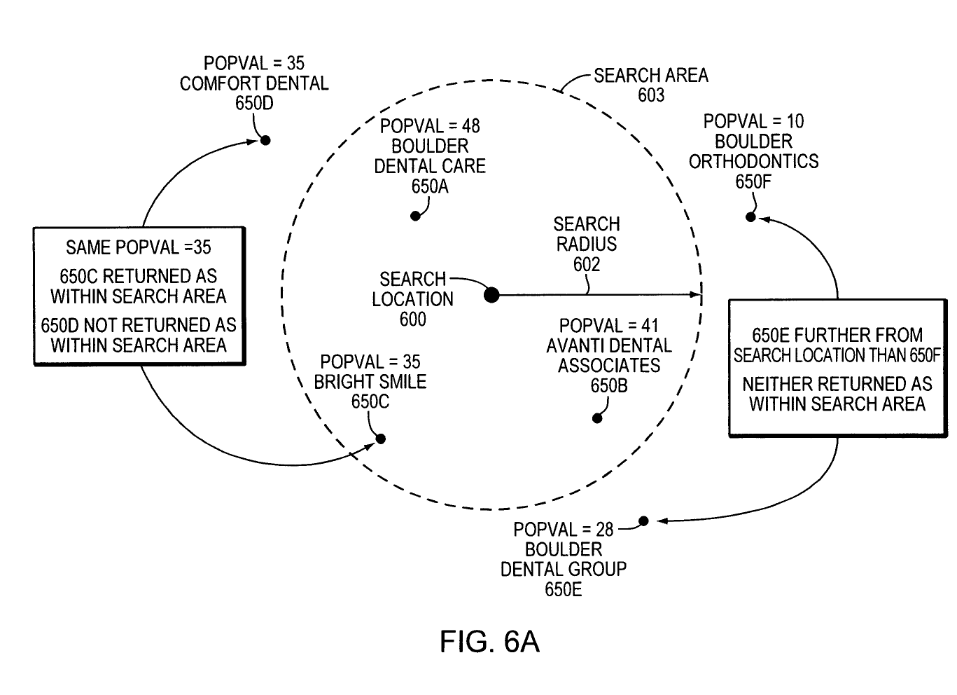

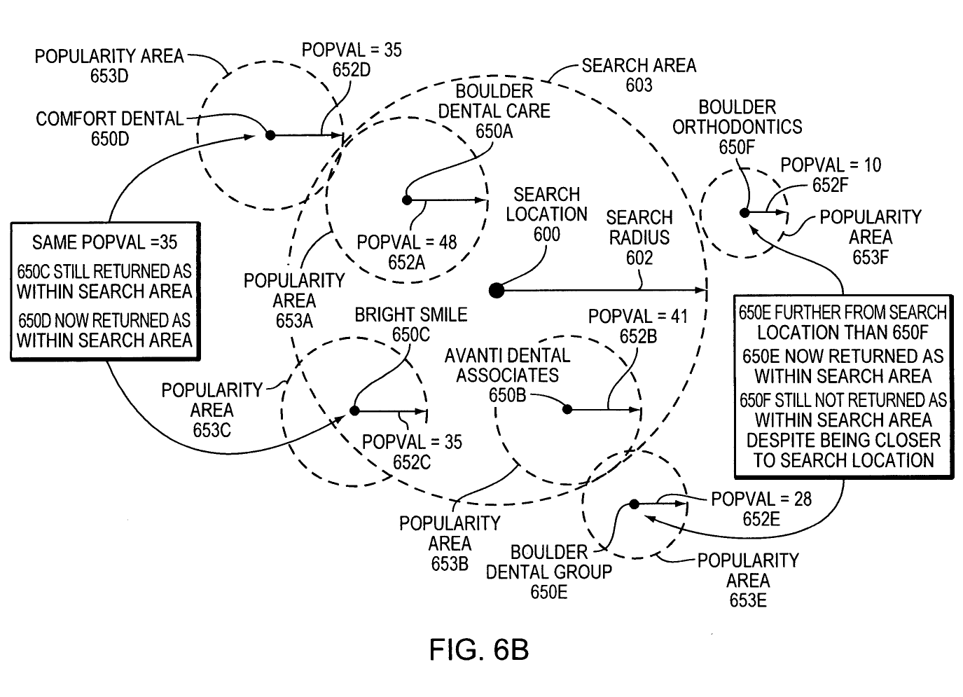

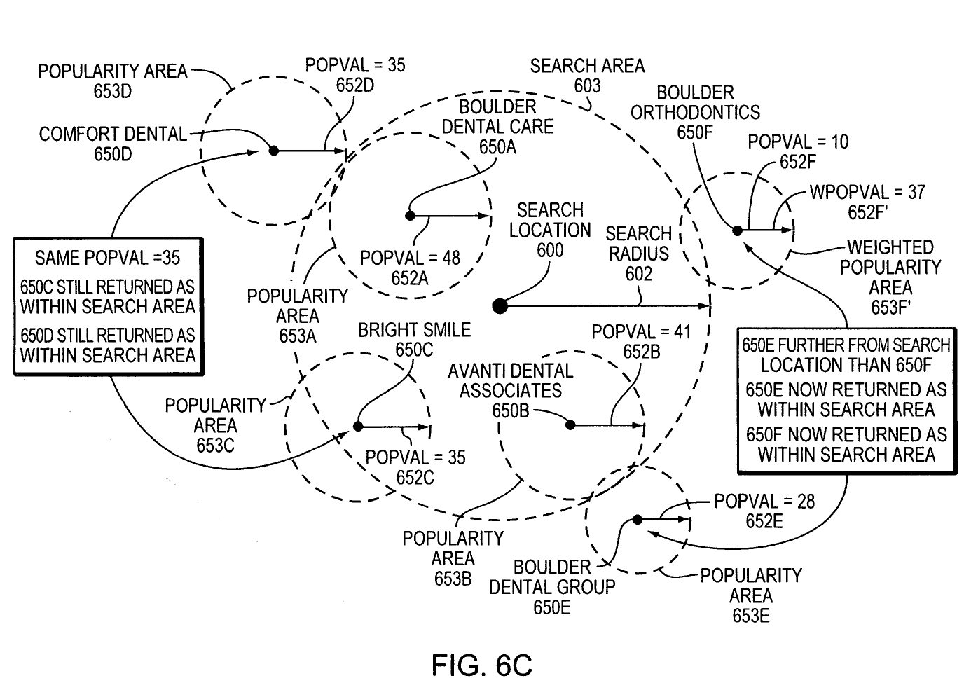

FIGS. 6A-6C illustrate abstract, conceptual ways to visualize the returned listings 650a-650f (corresponding to the results 250a-250f shown in the table illustrated in FIG. 2) in relation to a search location 600 associated with a directory assistance user, a search radius 602 specified in the search, and a search area 603 defined by the search

As illustrated in FIG. 6A, each search result 650a-650f that has been ordered according to its local popularity may be plotted according to the physical geographic location of the listings returned from the listings database 120 with respect to the location of the search 600. This location information may be used in returning search results. For example, only search results 650a-650c with geographic values falling within the search area 603 will be returned. Search results 650d-650f with geographic values falling outside the search area 603 are not returned.

The search location 600 may be the location of the directory assistance user or another location specified by the directory assistance user. The location of the directory assistance user may be determined by the directory assistance system via the reverse ANI database (170 of FIG. 1) or other emergency information from the e911 database (180 of FIG. 1) associated with the telephone 102 from which the directory assistance user is calling, either automatically or upon user prompt. The directory assistance system also may prompt the user to enter another location desired to be searched. This location 600 may be determined by zip code, speech recognition, or text entry via the telephone keypad. Moreover, the search radius 602 from the search location 600 may be determined by a default value used by the system and/or a value entered by the directory assistance user.

As illustrated in FIG. 6A, only the top three search results 650a-650c are returned as within the geographic search distance 602. However, one will notice that the third 650c and fourth 650d results have identical popularity values (e.g., POPVAL=35). Despite this, the fourth result 650d is not presented to the user because it falls outside of the search area 603 because it is three miles further away (compare the values of the third 250c and fourth 250d search results in the table illustrated in FIG. 2). Although search results may have identical popularity values (e.g., POPVAL=35 for the third search results 650c and the fourth search result 650d), one may be returned (e.g., the third search result 650c) while another is not (the fourth search result 650d) because the returned result (e.g., the third results 650c) is geographically closer to the search location 600 than the other, non-returned, result (e.g., the fourth results 650d).

FIG. 6B is a plot, similar to the plot of FIG. 6A, illustrating a second example embodiment in which the popularity values are used to expand the returned search results. For example, the respective popularity values 652a-652f of each returned search result 650a-650f may be used to calculate a respective popularity area 653a-653f. This popularity area may be applied in any search such that search results that normally would not have been returned because they were outside the search area 603 (e.g., the fourth search result 650d and the fifth search result 650e of FIG. 6A) may now be returned. For example, the fourth search result 650d is now returned as within the search area 603 because its popularity area 653d intersects the search area 603. Similarly, the fifth search result 650e is now returned as within the search area 603 because its popularity area 653e intersects the search area 603.

Expanding the returned search results may be important to users because, although the fourth search results 650d (i.e., Comfort Dental) is three miles further away from the search location 600 than the third search result 650c (i.e., Bright Smile)c, the user may have additional knowledge regarding the search results, such as positive experiences of other customers of Comfort Dental 650d, additional familiarity with its location, or may desire to choose that location for any other reason. Users also receive the benefit of receiving additional choices if those results are popular enough, but just beyond the search area. This “wiggle room” provides greater flexibility to the system.

However, despite this expansion by the calculation of popularity areas 653a-653f, a search result, such as the sixth search results 650f, which is geographically closer to the search location 600 than another returned search result, such as the fifth search result 650c, still may not be returned. For example, the sixth search result 650f, which fell just outside the search area 603 in FIG. 6A, is still not included in the returned results when its popularity area is applied in FIG. 6B. Here, the popularity of the more-distant fifth search result 650e is greater than that of the nearer search result 650f. Therefore, the popularity value 652f for the sixth search result 650f is not strong enough for its popularity area, calculated using the popularity value, to intersect the search area 603. Thus, popularity areas alone do not guarantee that a particular search result will be returned.

FIG. 6C is a plot, similar to the plot of FIG. 6B, illustrating a third example embodiment in which the popularity areas 653a-653f illustrated in FIG. 6B may be weighted. Weighted popularity areas (e.g., weighted popularity area 653f′) may be applied in any search such that search results that normally would not have been returned (e.g., the sixth search result 650f in FIGS. 6A-6B) because their location 650f, or popularity area 653f, were outside the search area 603 may now be returned. For example, the sixth search result 650f is unique among the six example search results 250a-250f in that its weighting multiplier (WMLTPLR) is a value greater than 1.00 (e.g., 3.70) such that the sixth search result has a weighted popularity value (WPOPVAL) of 37. As a result of this weighted popularity value, in this example embodiment, the sixth search result 650f is now returned as within the search area 603 because its weighted popularity area 653f′, as determined by its weighted popularity value 652f′ (WPOPVAL) of 37, intersects the search area 603. This may be important to advertisers in the system whose local popularity value is low (e.g., popularity value 652f), whether because of poor past performance, recent entry into a new market, or any other reason, because it allows these advertisers to increase the likelihood that their listing will be among those potentially returned to the user of the system.

Further, it allows these advertisers to increase the likelihood of their listings being heard or selected by directory assistance users by increasing the number of categories in which their listings have a high popularity, whether based on past user selections or artificially inflated by a weighting multiplier. For example, a user searching for an orthodontist will likely enter a query including the term “orthodontist,” which would lead to the selection of the “orthodontist” category. However, it is less likely that such a user would enter a query including the term “dentist” when looking for an orthodontist, despite any similarity between the practices. By artificially inflating the popularity value of a search result, an advertiser may have its listing returned as a result when it normally would not have been returned without the weighting multiplier. Therefore, in addition to paying any advertising fees to the directory assistance service provider for playing advertisements for the advertiser, the advertiser may pay a premium in exchange for the artificial inflation of their listing's popularity value via a weighting multiplier.

While this invention has been particularly shown and described with references to example embodiments thereof, it will be understood by those skilled in the art that various changes in form and details may be made therein without departing from the scope of the invention encompassed by the appended claims.

What is claimed is:

1. A method of ordering search results in response to a directory assistance search request by a directory assistance user in a public telecommunication network, comprising:
examining the search request to identify a category associated with the search request;
searching a database for search results categorized with the category, the search results including a geographic value and a popularity value, the popularity value being indicative of a number of selections of the respective search result when returned as a search result of previous search requests made by previous directory assistance users with locations proximate to a location associated with the directory assistance user;
returning search results categorized within the category and having geographic values within a distance from the location associated with the directory assistance user; and
ordering the returned search results according to their respective popularity values.

2. The method of claim 1 further comprising determining the location associated with the directory assistance user by querying a reverse Automatic Number Identifier (ANI) lookup database with a telephone number associated with the user.

3. The method of claim 1 further comprising determining the location associated with the directory assistance user by emergency location (e911) information associated with the directory assistance user.

4. The method of claim 1 further comprising determining the location associated with the directory assistance user by examining a response to a directory assistance user prompt.

5. The method of claim 4 wherein the response to the directory assistance user prompt is a geographic location of the directory assistance user.

6. The method of claim 4 wherein the response to the directory assistance user prompt is a geographic location different than a geographic location of the directory assistance user.

7. The method of claim 1 wherein the distance from the location associated with the directory assistance user is a preconfigured value.

8. The method of claim 1 further comprising determining the distance from the location associated with the directory assistance user by examining a response to a directory assistance user prompt.

9. The method of claim 1 wherein the geographic value associated with each search result includes a geographic location of the search result.

10. The method of claim 1 further comprising determining the geographic value associated with each search result according to an area defined by a geographic location of the search result and its respective popularity value.

11. The method of claim 1 further comprising determining the geographic value associated with each search result according to an area defined by a geographic location of the search result, its respective popularity value, and a weighting multiplier.

12. The method of claim 1 further comprising:
maintaining each popularity value in the database; and
incrementing the popularity value of a search result selected from the ordered search results by the directory assistance user to indicate the further selection by the directory assistance user.

13. The method of claim 1 further comprising:
determining the popularity value of a search result by examining records of search results of previous search requests to determine the number of selections of each respective returned search result.

14. A system for ordering search results in response to a directory assistance search request by a directory assistance user in a public telecommunication network, comprising:
a database; and
a processing station configured to examine the search request to identify a category associated with the search request; search the database for search results categorized within the category, the search results including a geographic value and a popularity value indicative of a number of selections of the respective search result when returned as a search result of previous search requests made by previous directory assistance users with locations proximate to a location associated with the directory assistance user; return search results categorized within the category and having geographic values within a distance from the location associated with the directory assistance user; and order the returned search results according to their respective popularity values.

15. The system of claim 14 where the processing station is further configured to determine the location associated with the directory assistance user by querying a reverse Automatic Number Identifier (ANI) lookup database with a telephone number associate with the user.

16. The system of claim 14 wherein the processing station is further configured to determine the location associated with the directory assistance user by emergency location information (e911) associated with the directory assistance user.

17. The system of claim 14 wherein the processing station is further configured to determine the location associated with the directory assistance user by examining a response to a directory assistance user prompt.

18. The system of claim 17 wherein the response to the directory assistance user prompt is a geographic location of the directory assistance user.

19. The system of claim 17 wherein the response to the directory assistance user prompt is a geographic location different than a geographic location of the directory assistance user.

20. The system of claim 14 wherein the distance from the location associated with the directory assistance user is a preconfigured value.

21. The system of claim 14 wherein the processing station is further configured to determine the distance from the location associated with the directory assistance user by examining a response to a directory assistance user prompt.

22. The system of claim 14 wherein the geographic value associated with each search result includes a geographic location of the search result.

23. The system of claim 14 wherein the processing station is further configured to determine the geographic value associated with each search result according to an area defined by a geographic location of the search result and its respective popularity value.

24. The system of claim 14 wherein the processing station is further configured to determine the geographic value associated with each search result according to an area defined by a geographic location of the search result, its respective popularity value, and a weighting multiplier.

25. The system of claim 14 wherein the processing station is further configured to maintain each popularity value in the database, and increment the popularity value of a search result selected from the ordered search results by the directory assistance user to indicate the further selection by the directory assistance user.

26. The system of claim 14 wherein the processing station is further configured to determine the popularity value of a search result by examining records of search results of previous search requests to determine the number of selections of each respective returned search result.

27. A system for ordering search results in response to a directory assistance search request by a directory assistance user in a public telecommunication network, comprising:
a database;
means for examining the search request to identify a category associated with the search request;
means for searching a database for search results categorized with the category, the search results including a geographic value and a popularity value, the popularity value being indicative of a number of selections of the respective search result when returned as a search result of previous search requests made by previous directory assistance users with locations proximate to a location associated with the directory assistance user;
means for returning search results categorized within the category and having geographic values within a distance from the location associated with the directory assistance user; and
means for ordering the returned search results according to their respective popularity values.
